(19) United States
(12) Patent Application Publication
(10) Pub. No.: US 2021/0218162 A1
(43) Pub. Date: Jul. 15, 2021

(54) WEDGE CABLE CONNECTOR WITH TERMINAL PAD

(71) Applicant: Burndy, LLC, Manchester, NH (US)

(72) Inventors: Jeremy Jushchyshyn, Willow Grove, PA (US); Nicholas Polidori, Medford, NJ (US)

(21) Appl. No.: 17/149,301

(22) Filed: Jan. 14, 2021

Related U.S. Application Data
(60) Provisional application No. 62/961,042, filed on Jan. 14, 2020.

(51) Int. Cl. H01R 4/50; H01R 4/38

(52) U.S. Cl. CPC H01R 4/5091; H01R 4/38

(57) ABSTRACT

An electrical connector is disclosed which is particularly adapted to electrically and mechanically connect a conductor to a terminal. The connector includes a C-shaped frame having a curved top wall adapted to fit over a conductor. A mounting surface with through holes for mechanical fastening to pad type equipment or fixture. A fastener-operated wedge assembly is carried within the frame between a conductor receiving position and a conductor clamping position. The wedge assembly has a wedge body with a contact surface adapted to contact the conductor when the wedge body is moved from the conductor receiving position to the conductor clamping position. The fastener positively moves the wedge body between the positions so that the clamping action of the connector can be tightened or loosened as desired. A head portion of the fastener may include a breakaway feature to help prevent overtightening of the fastener.

### CROSS REFERENCE TO RELATED APPLICATIONS

The present disclosure is based on and claims benefit from co-pending U.S. Provisional Patent Application Ser. No. 62/961,042 filed on Jan. 14, 2020 entitled “Wedge Cable Connector with Terminal Pad” the entire contents of which are incorporated herein by reference.

### BACKGROUND

### Field

The present disclosure relates generally to electrical connectors. More particularly, the present disclosure relates to wedge type electrical connectors having a terminal pad and adapted to electrically and mechanically connect an electrical conductor to a terminal.

### Description of the Related Art

Wedge type electrical connectors that connect one conductor to another conductor are known. Electrical connectors may be adapted to electrically and mechanically connect conductors within a transmission or distribution circuit. For example, a typical electrical wedge type connector may be used to connect a main conductor to a tap or run conductor. Wedge type tap connectors typically include a C-shaped body having a curved top wall adapted to fit over a main conductor and a curved bottom wall adapted to receive a tap conductor. A bolt-operated wedge is carried by the bottom of the C-shaped body and may include an elongated recess for supporting the tap conductor. A conductor interface has a handle thereon which allows the interface to be easily placed within the C-shaped connector body between the conductors. The bolt positively moves the wedge both in and out of the C-shaped body so that a clamping action of the connector can be tightened or loosened as desired.

### SUMMARY

The present disclosure provides exemplary embodiments of wedge type electrical connector assemblies adapted to electrically and mechanically connect an electrical conductor to a terminal. The wedge type electrical connector assemblies according to the present disclosure integrates a terminal pad into a frame of a wedge type electrical connector assembly reducing the number of components forming the connector assembly and creating the electrically conductive path between an electrical conductor and a terminal.

In an exemplary embodiment, the wedge type electrical power connector assembly includes a frame, a terminal pad and a wedge assembly. The frame has first conductor guide wall, a wedge guide wall, and a rear wall between the first conductor guide wall and the wedge guide wall. The guide walls and rear wall form a wedge receiving channel. The terminal pad extends from the frame such that the terminal pad is parallel to a longitudinal axis of the frame. As an example, the terminal pad may extend from the rear wall or the wedge guide wall of the frame. The terminal pad has at least one mounting aperture extending therethrough. As an example, the at least one mounting aperture may be a smooth bore aperture or a threaded aperture. The wedge assembly has a wedge and a fastener. The wedge has a body shaped to fit within the wedge receiving channel of the frame and a fastener holder extending from the body. The body has a top wall with a contact surface adapted to contact a conductor in contact with the first conductor guide wall. The fastener may be a single threaded bolt or a multi-threaded bolt. The fastener is movably coupled to the fastener holder of the wedge body, and the frame includes a bore configured to receive the fastener so that the fastener can move the wedge in the wedge receiving channel of the frame from a first end of the frame toward a second end of the frame.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a perspective view of a terminal extending from a transformer bushing with an exemplary embodiment of a wedge type electrical cable connector assembly according to the present disclosure attached to the terminal, and a conductor secured to the wedge type electrical cable connector assembly;

FIG. 2 is a perspective view of the wedge type electrical cable connector assembly of FIG. 1, illustrating a terminal pad extending from a frame of the electrical cable connector assembly;

FIG. 3 is a first end elevation view of the wedge type electrical cable connector assembly of FIG. 2;

FIG. 4 is a second end elevation view of the wedge type electrical cable connector assembly of FIG. 2;

FIG. 5 is a side elevation view of the wedge type electrical cable connector assembly of FIG. 2;

FIG. 6 is a top plan view of the wedge type electrical cable connector assembly of FIG. 2;

FIG. 7 is a bottom plan view of the wedge type electrical cable connector assembly of FIG. 2;

FIG. 8 is a perspective view of a terminal extending from a transformer bushing with another exemplary embodiment of a wedge type electrical cable connector assembly according to the present disclosure attached to the terminal, and a conductor secured to the wedge type electrical cable connector assembly;

FIG. 9 is a perspective view from an end of the wedge type electrical cable connector assembly of FIG. 8, illustrating a spacer positioned in a wedge of the wedge type electrical cable connector assembly attaching a smaller gauge conductor to the wedge type electrical cable connector assembly;

FIG. 10 is a perspective view of a terminal extending from a transformer bushing with another exemplary embodiment of a wedge type electrical cable connector assembly according to the present disclosure attached to the terminal, and a conductor secured to the wedge type electrical cable connector assembly;

FIG. 11 is a perspective view from an end of the wedge type electrical cable connector assembly of FIG. 10, illustrating another exemplary embodiment of a terminal pad extending from a frame of the wedge type electrical cable connector assembly; and

FIG. 12 is a perspective view from an end of the wedge type electrical cable connector assembly similar to FIG. 11, illustrating a spacer positioned in a wedge of the wedge type electrical cable connector assembly attaching a smaller gauge conductor to the wedge type electrical cable connector assembly.

### DETAILED DESCRIPTION

The present disclosure provides exemplary embodiments of improved wedge type electrical cable connectors adapted to electrically and mechanically connect a conductor to a terminal. For ease of description, the wedge type electrical cable connector assemblies contemplated by the present disclosure may also be referred to herein as the “connectors” in the plural and the “connector” in the singular. The conductors referenced herein include, for example, main or transmission line conductors, tap conductors, branch conductors and/or run conductors. The terminal referenced herein may be included in, for example, bolted connections to equipment and/or bus bars, such as transformers, e.g., transformer bushings, in-line switches or other type of switch gear. The terminal pad described herein is representative of any conductive pad mounting surface used to mate a wedge connector to another electrical pad surface. As a non-limiting example, a terminal pad may be a NEMA pad type connection.

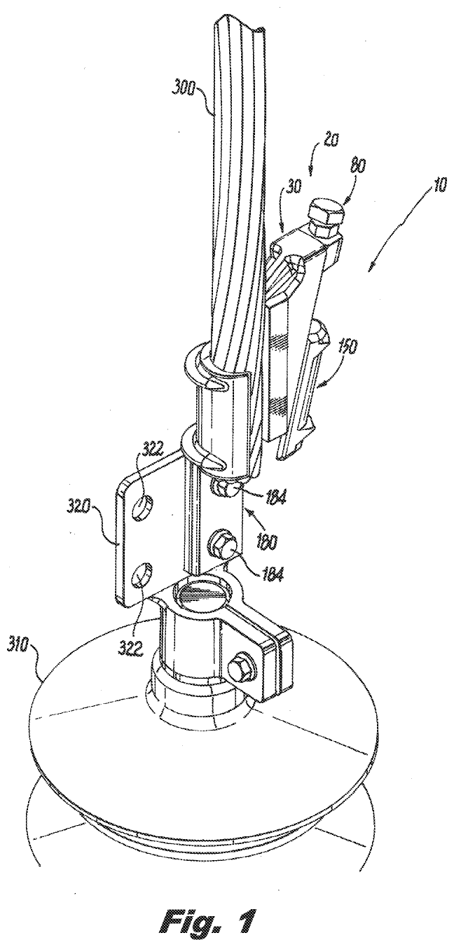

Referring to FIG. 1-7, an exemplary embodiment of a connector 10 according to the present disclosure is shown. As shown in FIG. 1, the connector 10 can be used to connect a conductor 300 to a transformer bushing 310. More specifically, the conductor 300 is secured to the connector 10 and the connector is secure to a terminal 320 attached to the transformer bushing 310. In the embodiment of FIGS. 1-6, the connector 10 includes a wedge assembly 20 and a frame 150. The wedge assembly 20 is operatively coupled to or interconnected with the frame 150 so that the wedge assembly can slide or glide along the frame to wedge or secure the conductor 300 to the frame 150 so that an electrically conductive path is created between the conductor and the frame. The wedge assembly 20 and frame 150 are made of an electrically conductive material that has sufficient rigidity to withstand the forces applied by the wedge assembly 20 against the frame 150 when mechanically connecting the conductor 300 to the frame. Non-limiting examples of such electrically conductive and rigid materials include aluminum, aluminum alloys, stainless steel, galvanized steel, copper and copper alloys.

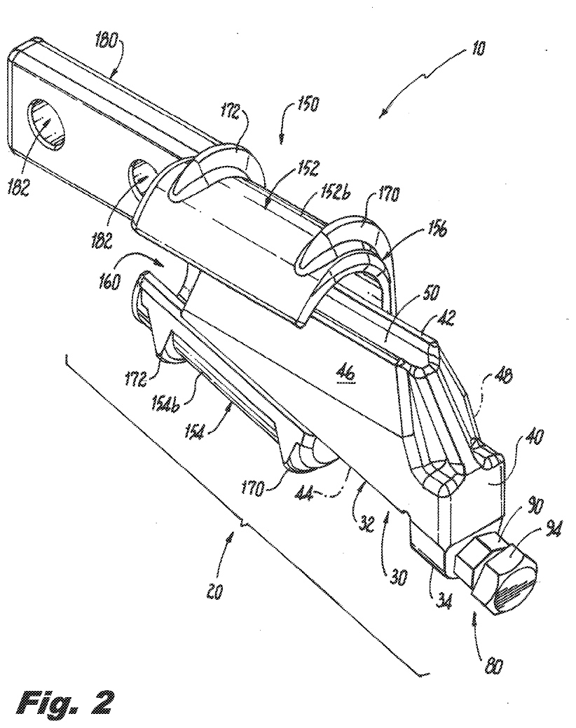

Referring to FIGS. 2-7, the wedge assembly 20 includes a wedge 30 and a fastener 80. The wedge 30 includes a body 32 and a fastener holder 34. The body 32 has a front wall 38, a rear wall 40, a top wall 42, a bottom wall 44 and side walls 46 and 48. The wedge body 32 is shaped to fit within the frame 150. At least a portion of the top wall 42 includes a contact surface 50. The contact surface 50 may be in the form of an elongated recess or groove as shown. The contact surface 50 is preferably configured to contact and cooperate with a conductor positioned in the frame 150. The fastener holder 34, seen in FIGS. 2 and 7, extends from the bottom wall 44 of the body 32 and includes an aperture 54, seen in FIG. 7, configured and dimensioned to receive the fastener 80 such that the fastener can rotate relative to the aperture 54. Preferably, the fastener holder 34 is positioned at or in proximity to the rear wall 40 of the body 32 and extends from the bottom wall 44 so that the aperture 54 of the fastener holder 34 is aligned with a bore in the frame 150 used to couple the wedge assembly 20 to the frame 150. However, the present disclosure contemplates that the fastener holder 34 can be positioned at any location on the body 32 so long as the aperture 54 of the fastener holder 34 aligns with the bore in the frame 10 when the wedge assembly 20 is coupled to the frame 150.

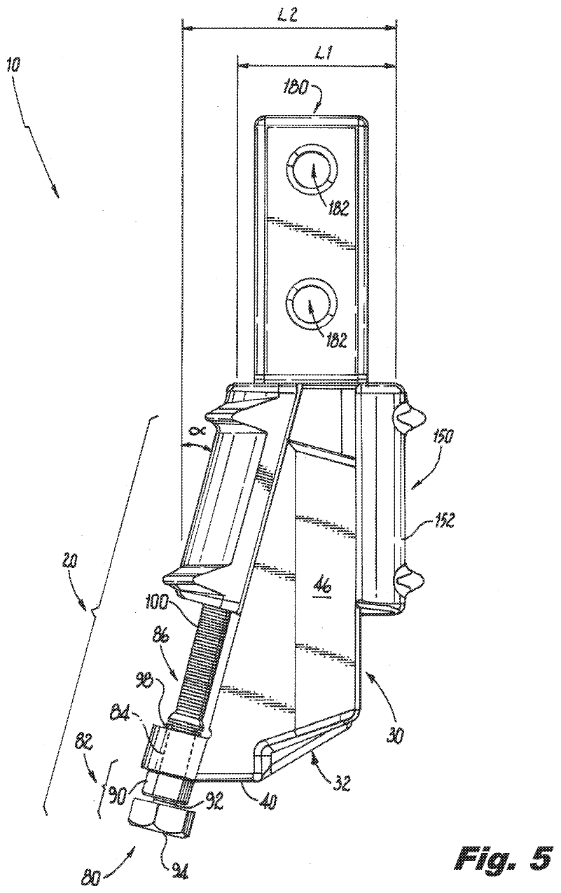

Referring now to FIG. 5, the fastener 80 may be any fastener suitable to releasably secure the wedge assembly 20 to the frame 150 as described herein. In the exemplary embodiment shown, the fastener 80 is an elongated bolt having a head portion 82 followed by a shoulder 84 within the aperture 54 in the fastener holder 34, followed by a threaded portion 86. The head portion 82 may be, for example, a breakaway head configuration so that a portion of the head shears or breaks-away from the head portion. In other embodiments, the head portion 82 may be a convention hexagonal bolt head configuration. The head portion 82 shown is a breakaway head configuration. Generally, the breakaway head 82 includes a head nut 90, a shear stud 92 and a cap nut 94. The head nut 90 may be a hexagonal shaped nut that is used when removing the fastener 80 from the frame 150. The shear stud 92 extends between the head nut 90 and the cap nut 94. The shear stud 92 may be, for example, a circular structure that may have a tapered cross section, where the narrow portion of the taper is attached to the head nut 90 and the wide portion of the taper is attached to the cap nut 94. The shear stud 92 is configured and dimensioned to shear at or above a threshold torque so that the cap nut 94 shears or breaks away from the head portion 82. The diameters of the narrow portion and wide portion of the shear stud 92 are determined by the desired predetermined torque at which the shear stud is to shear and the material the shear stud is made of. For example, if the predetermined torque is to be in the range of about 145 inch-lbs. to about 160 inch-lbs. The diameter for the narrow portion of a shear stud 92 made of aluminum may be in the range from about 0.2 inches to about 0.3 inches, and the shear stud 92 tapers outward from the narrow portion at an angle that can range from about 5 degrees to about 30 degrees. The cap nut 94 may be a hexagonal shaped nut that is used when securing the conductor to the frame 150 and that shears or breaks away when tightened sufficient, i.e., to the desired torque range, to clamp the conductor to the frame 150. A more detailed description of a shear type head portion is described in commonly owned U.S. Pat. No. 10,465,732 which is incorporated herein in its entirety by reference.

Continuing to refer to FIG. 5, the shoulder 84 of the fastener 80 is configured and dimensioned to fit within the aperture 54 of the fastener holder 34 when the fastener 80 is attached to the body 32 of the wedge 30. Preferably, the shoulder 84 has a smooth outer surface so that when the shoulder is within the aperture 54, the shoulder 84 can freely rotate relative to the fastener holder 34, which permits the fastener 80 to freely rotate. Between the shoulder 84 and the threaded portion 86 is a retaining groove used to at least partially attach the fastener 80 to the body 32 of the wedge 30 using, for example, a snap ring 98. The threading 100 on the outer surface of the threaded portion 86 of the fastener 80 is complementary to the threading of the threaded bore in the frame 150, which acts as a nut. The threading 100 of the threaded portion 86 may be single-lead threading or multi-lead threading, e.g., double-lead, triple-lead or quadruple-lead threading, as is known.

The attachment of the fastener 80 to the fastener holder 34 will be described. Initially, the threaded portion 86 of the fastener 80 is inserted into the aperture 54 of the fastener holder 34 until the shoulder 84 of the fastener is within the aperture 54 of the fastener holder 34, as shown. The retaining ring 98 is then snapped onto the groove in the fastener 80 between the shoulder 84 and the threaded portion 86. At this point, the fastener 80 is releasably and movably attached to the fastener holder 34 of the wedge body 32.

Continuing to refer to FIGS. 2-7, in this exemplary embodiment, the frame 150 is a C-shaped member or body. The frame 150 has a first conductor guide wall 152, a wedge guide wall 154 and a rear wall 156 between the first conductor guide wall 152 and the wedge guide wall 154. Between the first conductor guide wall 152, the wedge guide wall 154 and the rear wall 156 is a wedge receiving channel 160, seen in FIG. 2. In the embodiment shown, the first conductor guide wall 152, the wedge guide wall 154, the rear wall 156 and the wedge receiving channel 160 form the C-shaped body.

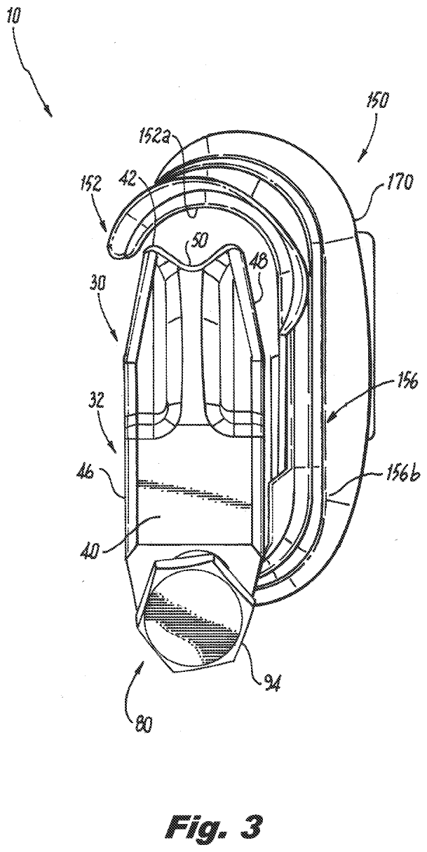

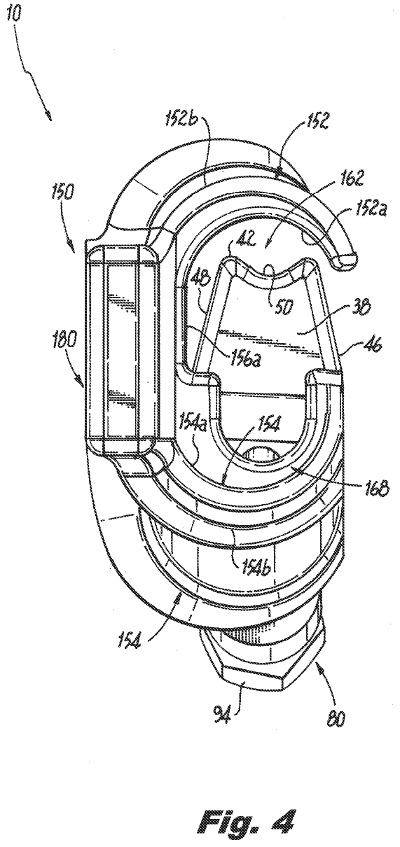

The first conductor guide wall 152 has an inner surface 152a and an outer surface 152b, seen in FIG. 4. The inner surface 152a of the first conductor guide wall 152 is shaped, e.g., arcuate shaped, to form a first conductor groove 162 that is configured and dimensioned to receive or fit at least partially around a conductor, e.g., conductor 300. The wedge guide wall 154 has an inner surface 154a and an outer surface 154b. The inner surface 154a of the wedge guide wall 154 is shaped, e.g., arcuate shaped, to form a wedge groove 168 that is configured and dimensioned to receive at least partially the wedge 30 and includes a bore 169, seen in FIG. 7, configured and dimensioned to receive the fastener 80. The rear wall 156 has an inner surface 156a and an outer surface 156b, seen in FIGS. 3 and 4. In this exemplary embodiment, the inner surface 156a and the outer surface 156b of the rear wall 156 are substantially flat.

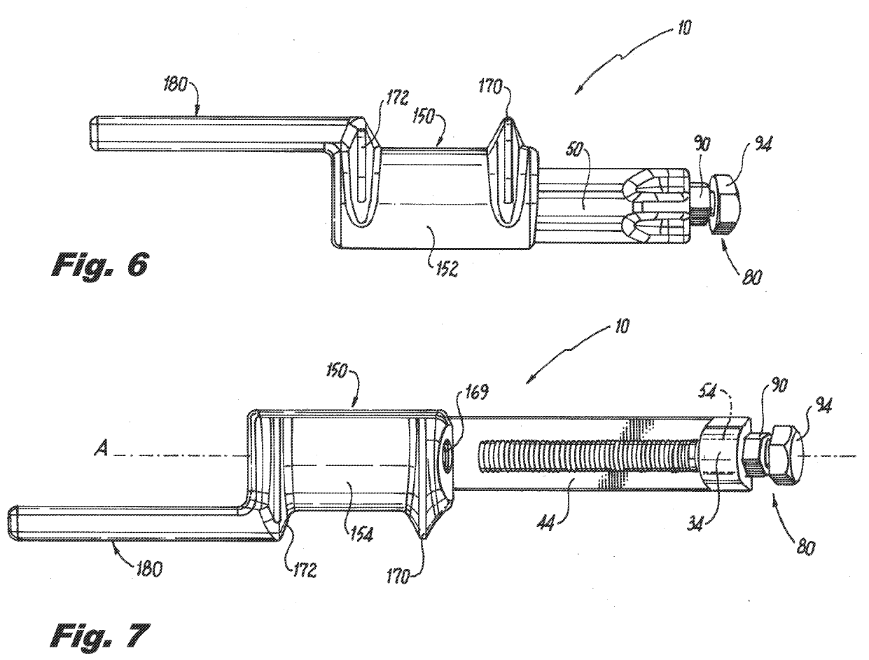

The frame 150 may also include one or more stiffening ribs that provide structural stiffness to further assist the frame in withstanding the forces applied by the operation of the wedge assembly 20. The one or more ribs may be integrally or monolithically formed into the frame or the one or more ribs may be secured to the frame using welds, mechanical fasteners or adhesives. In the exemplary embodiment shown, there are two ribs 170 and 172, seen in FIGS. 2 and 6, monolithically formed into and extending from the frame 150. More specifically, the first rib 170 extends along a portion of the outer surface 152b of the first conductor guide wall 152, along the outer surface 156b of the rear wall 156 and along a portion of the outer surface 154b of the wedge guide wall 154. The first rib 170 may be symmetrically or asymmetrically shaped in order to provide the additional structural integrity sufficient to withstand the forces applied by the operation of the wedge assembly 20. In the embodiment shown, the first rib 170 is symmetrically shaped. The second rib 172 extends along a portion of the outer surface 152b of the first conductor guide wall 152, along the outer surface 156b of the rear wall 156 and along a portion of the outer surface 154b of the wedge guide wall 154. The second rib 172 may be symmetrically or asymmetrically shaped in order to provide the additional structural integrity sufficient to withstand the forces applied by the operation of the wedge assembly 20. In the embodiment shown, the second rib 172 is symmetrically shaped.

Referring again to FIGS. 1-7, as noted above, the connector 10 is a wedge type connector having a wedge assembly 20 and a frame 150 that are operatively coupled or interconnected so that a conductor, e.g., conductor 300, can be wedged in the frame 150 so as to clamp the conductor to the connector 10, as shown. In order for the wedge assembly 20 to wedge or clamp the conductor within the frame 150, the wedge receiving channel 160 at a first end of the frame 150 has a length “L1” and the wedge receiving channel 160 at a second end of the frame 150 has a length “L2.” In the embodiment shown, the length “L1” is less than the length “L2” such that one or both of the guide walls 152 and 154 are tapered relative to a longitudinal axis of the frame 150. In the embodiment shown, the second conductor guide wall 154 is at an angle “a” relative to a longitudinal axis of the frame 150. Having the length “L2” of the wedge receiving channel 160 at a second end of the frame 150 greater than the length “L1” of the wedge receiving channel 160 at a first end of the frame 150 permits conductors to be inserted into the connector 10 from the wedge receiving channel 160 at a second end of the frame 150 and when the fastener 80 is tightened so that the wedge 30 moves toward the first end of the frame 150 to wedge or clamp the conductor within the frame 150.

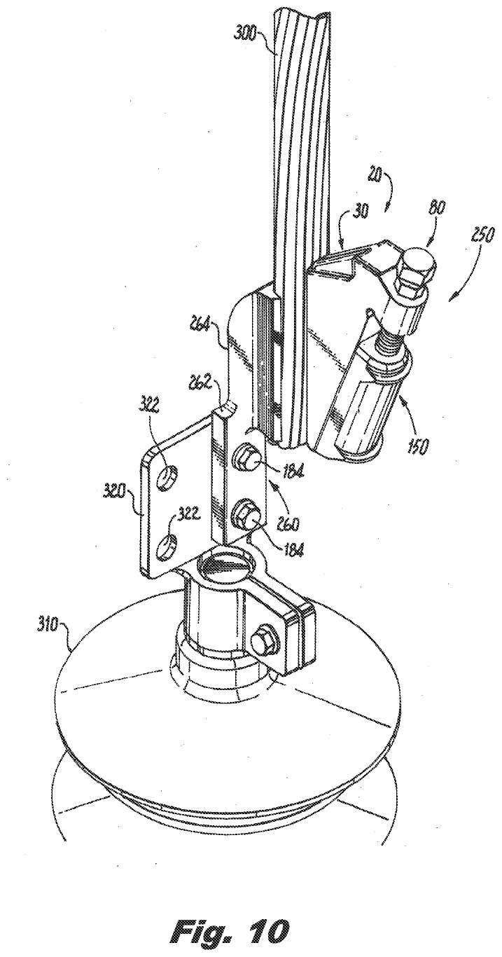

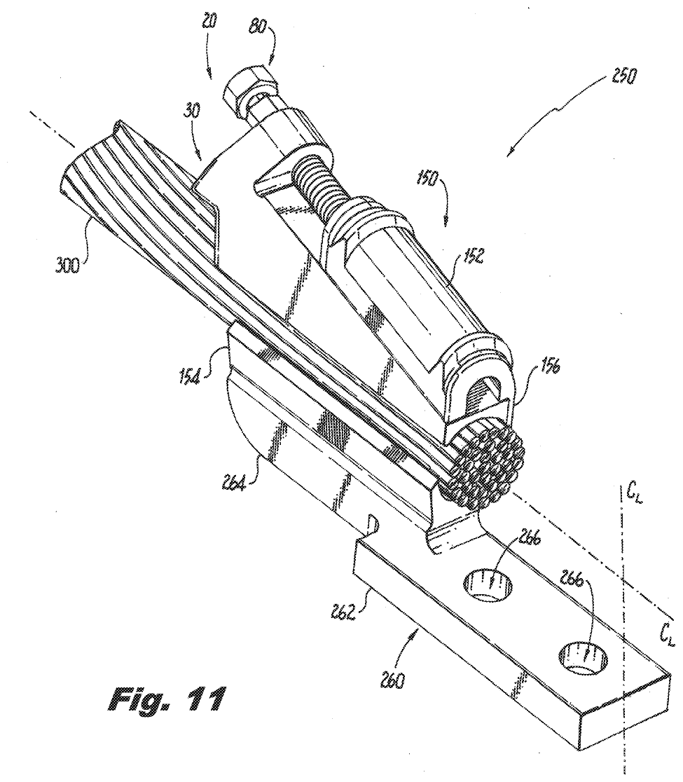

A terminal pad 180 may be integrally or monolithically formed into the frame 150 or the terminal pad 180 may be secured to the frame using welds, mechanical fasteners or adhesives. The terminal pad 180 may be rectangular, square, circular of other symmetrical shape, or the terminal pad 180 may have an asymmetrical shape to mate with a terminal, e.g., terminal 320. In the embodiment shown, the terminal pad 180 is rectangular in shape. The terminal pad 180 extends from the frame 150 and is used to secure the connector 10 to a terminal, e.g., terminal 320 which in this exemplary embodiment is connected to a transformer bushing 310. In the exemplary embodiments of the connector shown in FIGS. 1-9, the terminal pad 180 extends from the rear wall 156 of the frame 150 and is substantially parallel to the longitudinal axis “A” of the connector 10. In the exemplary embodiments of the connector shown in FIGS. 10-12, the terminal pad 180 extends from the guide wall 154 of the frame 150 and is substantially parallel to the longitudinal axis “A” of the connector 10. However, the present disclosure contemplates that the terminal pad 180 may extend from the guide wall 152 of the frame and the terminal pad 180 may extend from the frame 150 at an angle relative to the longitudinal axis “A” of the frame 150. The terminal pad 180 includes one or more mounting apertures 182 through which a fastener 184 may be passed to secure the connector 10 to a terminal, e.g., terminal 320. For example, the mounting aperture 182 may be a smooth bore aperture, the fastener 184 may be a threaded bolt and the terminal, e.g., terminal 320, may include a mounting aperture 322 that is threaded so that the threaded bolt can be passed through the smooth bore mounting aperture 182 into the threaded aperture in the terminal and tightened. As another example, the mounting aperture 182 may be a threaded aperture, the fastener 184 may be a threaded bolt and the terminal, e.g., terminal 320, may include a mounting aperture 322 that is a smooth bore aperture so that the threaded bolt can be passed through the smooth bore mounting aperture 322 into the threaded mounting aperture 182 and tightened. As yet another example, the mounting aperture 182 may be a smooth bore aperture, the fastener 184 may be a threaded bolt and nut and the terminal, e.g., terminal 320, may include a mounting aperture 322 that is smooth so that the threaded bolt can pass through the apertures 182 and 322 and the nut can be used to secure the terminal pad 180 to the terminal, e.g., terminal 320.

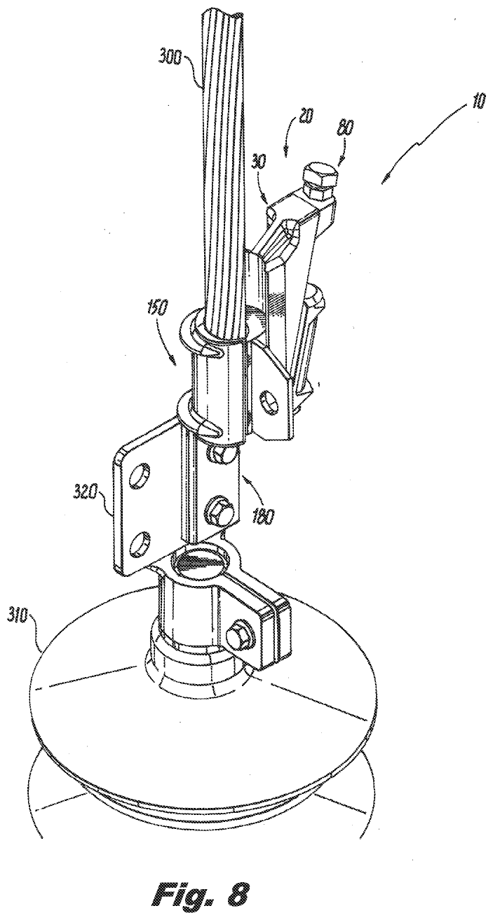

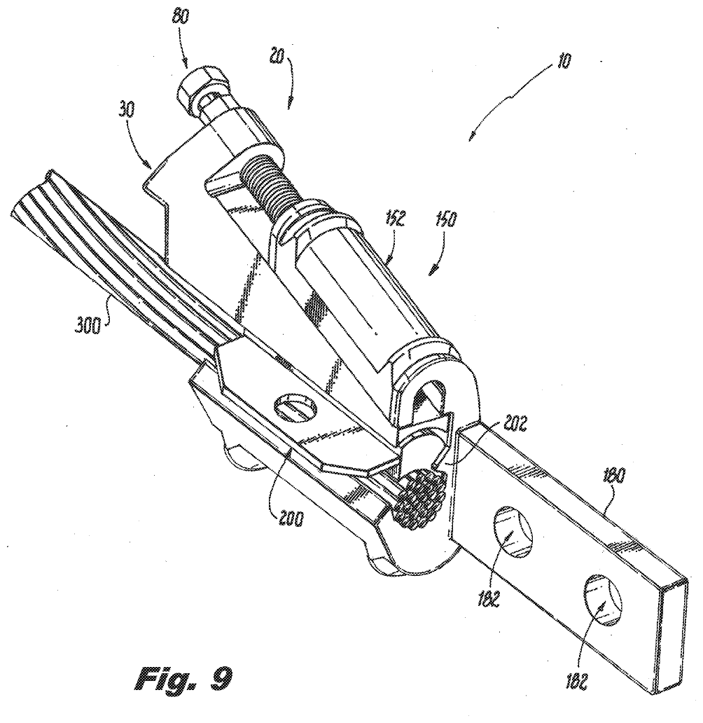

FIGS. 1-7 show a larger size conductor, e.g., conductor 300, clamped to the connector 10. FIGS. 8 and 9 show a smaller size conductor, e.g., conductor 300, clamped to the connector 10. As a non-limiting example, a larger size conductor is a conductor having an outer diameter that is equal to or greater than 1 inch, and a smaller size conductor is a conductor having an outer diameter that is less than 1 inch. As described above, having the length “L2” of the wedge receiving channel 160 at a second end of the frame 150 greater than the length “L1” of the wedge receiving channel 160 at a first end of the frame 150 permits conductors to be inserted into the connector 10 from the wedge receiving channel 160 at a second end of the frame 150 so that when the fastener 80 is tightened the wedge 30 moves toward the first end of the frame 150 to wedge or clamp the conductor within the frame 150. The connector 10 is substantially the same as the connector described above, except to clamp a smaller size conductor to the frame 150, a conventional spacer 200 may be used to fill a gap between the wedge 30 and the conductor, e.g., conductor 300. The spacer 200 ensures the wedge 30 stays within the frame 150 when clamping the conductor to the frame 150. A stop 202 on the frame 150 aligns the spacer 200 within the frame 150 and blocks the spacer 200 from exiting the first end of the frame 150 when a conductor is being clamped to the frame.

Referring now to FIGS. 10-12, another exemplary embodiment of the connector according to the present disclosure is shown. In this exemplary embodiment, the connector 250 is substantially the same as the connector 10 described above such that like elements will be given like reference numerals. The difference between connector 250 and connector 10 is that the terminal pad 260 extends from the guide wall 154 of the frame 150 and is substantially parallel to the longitudinal axis “A” of the connector 250. In this embodiment, to provide added strength to the connection of the terminal pad 260 to the frame 150, the terminal pad includes a termination portion 262 and a connection portion 264. The termination portion 262 includes one or more mounting apertures 266 through which a fastener 184 may be passed to secure the connector 250 to a terminal, e.g., terminal 320. For example, the fastener 184 may be a threaded bolt and the terminal, e.g., terminal 320, may include a mounting aperture 322 that is threaded so that the threaded bolt can be secured to the threaded aperture in the terminal. As another example, the fastener 184 may be a threaded bolt and nut, and the terminal, e.g., terminal 320, may include a mounting aperture 322 that is smooth so that the threaded bolt can pass through the aperture in the terminal and the nut can be used to secure the terminal pad 180 to the terminal, e.g., terminal 320.

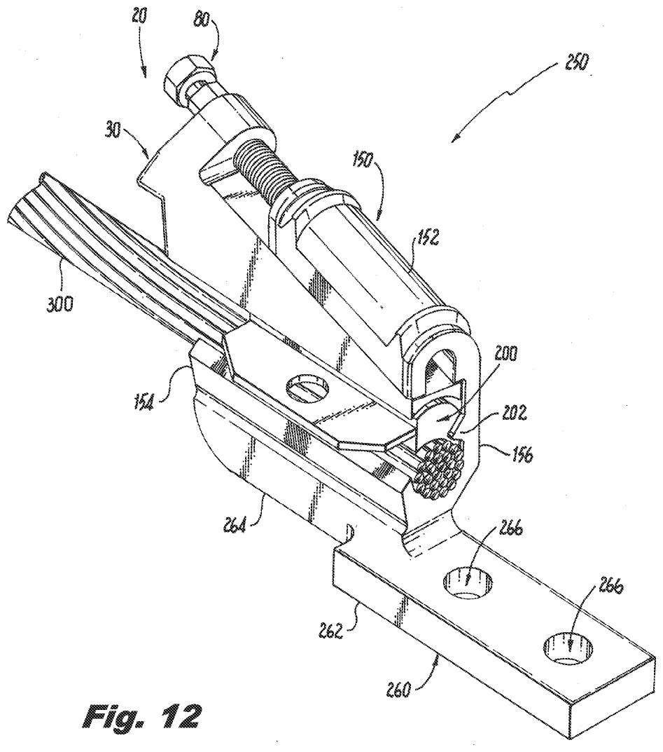

Continuing to refer to FIGS. 10-12, the connection portion 264 of the terminal pad 260 may be integrally or monolithically formed into the frame 150, or the connection portion 264 of the terminal pad 260 may be secured to the frame using welds, mechanical fasteners or adhesives. The termination portion 262 of the terminal pad 260 may be rectangular, square, circular of other symmetrical shape, or the termination portion 262 of the terminal pad 260 may have an asymmetrical shape to mate with a terminal, e.g., terminal 320. In the embodiment shown, the termination portion 262 of the terminal pad 260 is rectangular in shape. The terminal pad 260 extends from the frame 150 and is used to secure the connector 250 to a terminal, e.g., terminal 320 seen in FIG. 10, which in this exemplary embodiment is connected to a transformer bushing 310. FIG. 11 shows a larger size conductor, e.g., conductor 300, clamped to the connector 250. FIG. 12 shows a smaller size conductor, e.g., conductor 300, clamped to the connector 250. As a non-limiting example, a larger size conductor is a conductor having an outer diameter that is equal to or greater than 1 inch, and a smaller size conductor is a conductor having an outer diameter that is less than 1 inch. As described above, having the length “L2” of the wedge receiving channel 160 at a second end of the frame 150 greater than the length “L1” of the wedge receiving channel 160 at a first end of the frame 150 permits conductors to be inserted into the connector 250 from the wedge receiving channel 160 at a second end of the frame 150 so that when the fastener 80 is tightened the wedge 30 moves toward the first end of the frame 150 to wedge or clamp the conductor within the frame 150. The connector 250 of FIG. 12 is substantially the same as the connector of FIGS. 10 and 11, except to clamp a smaller size conductor to the frame 150, a conventional spacer 200 may be used to fill a gap between the wedge 30 and the conductor, e.g., conductor 300. The spacer 200 ensures the wedge 30 stays within the frame 150 when clamping the conductor to the frame 150. A stop 202 on the frame 150 aligns the spacer 200 within the frame 150 and blocks the spacer 200 from exiting the first end of the frame 150 when a conductor is being clamped to the frame.

While illustrative embodiments of the present disclosure have been described and illustrated above, it should be understood that these are exemplary of the disclosure and are not to be considered as limiting. Additions, deletions, substitutions, and other modifications can be made without departing from the spirit or scope of the present disclosure. Accordingly, the present disclosure is not to be considered as limited by the foregoing description.

What is claimed is:

1. A wedge type electrical power connector assembly comprising:
a frame having first conductor guide wall, a wedge guide wall, and a rear wall between the first conductor guide wall and the wedge guide wall, wherein the guide walls and rear wall form a wedge receiving channel;
a terminal pad extending from the frame such that the terminal pad is parallel to a longitudinal axis of the frame, the terminal pad having at least one mounting aperture extending therethrough; and
a wedge assembly having a wedge and a fastener, the wedge having a body shaped to fit within the wedge receiving channel of the frame and a fastener holder extending from the body, wherein the body has a top wall with a contact surface adapted to contact a conductor in contact with the first conductor guide wall.

2. The wedge type electrical power connector assembly according to claim 1, wherein the terminal pad extends from the rear wall of the frame such that the terminal pad is substantially perpendicular to the rear wall.

3. The wedge type electrical power connector assembly according to claim 1, wherein the terminal pad extends from the wedge guide wall of the frame such that the terminal pad is substantially perpendicular to the frame.

4. The wedge type electrical power connector assembly according to claim 1, wherein the at least one mounting aperture is a smooth bore aperture.

5. The wedge type electrical power connector assembly according to claim 1, wherein the at least one mounting aperture is a threaded aperture.

6. The wedge type electrical power connector assembly according to claim 1, wherein the fastener is movably coupled to the fastener holder, and wherein the frame includes a bore configured to receive the fastener.

7. A wedge type electrical power connector assembly comprising:
a frame having first conductor guide wall, a wedge guide wall, and a rear wall between the first conductor guide wall and the wedge guide wall, wherein the guide walls and rear wall form a wedge receiving channel;
a terminal pad extending from the rear wall of the frame such that the terminal pad is parallel to a longitudinal axis of the frame, the terminal pad having at least one mounting aperture extending therethrough; and
a wedge assembly having a wedge and a fastener, the wedge having a body shaped to fit within the wedge receiving channel of the frame and a fastener holder extending from the body, wherein the body has a top wall with a contact surface adapted to contact a conductor in contact with the first conductor guide wall.

8. The wedge type electrical power connector assembly according to claim 7, wherein the at least one mounting aperture is a smooth bore aperture.

9. The wedge type electrical power connector assembly according to claim 7, wherein the at least one mounting aperture is a threaded aperture.

10. The wedge type electrical power connector assembly according to claim 7, wherein the fastener is movably coupled to the fastener holder, and wherein the frame includes a bore configured to receive the fastener.

11. A wedge type electrical power connector assembly comprising:
a frame having first conductor guide wall, a wedge guide wall, and a rear wall between the first conductor guide wall and the wedge guide wall, wherein the guide walls and rear wall form a wedge receiving channel;
a terminal pad extending from the wedge guide wall of the frame such that the terminal pad is parallel to a longitudinal axis of the frame, the terminal pad having at least one mounting aperture extending therethrough; and
a wedge assembly having a wedge and a fastener, the wedge having a body shaped to fit within the wedge receiving channel of the frame and a fastener holder extending from the body, wherein the body has a top wall with a contact surface adapted to contact a conductor in contact with the first conductor guide wall.

12. The wedge type electrical power connector assembly according to claim 11, wherein the at least one mounting aperture is a smooth bore aperture.

13. The wedge type electrical power connector assembly according to claim 11, wherein the at least one mounting aperture is a threaded aperture.

14. The wedge type electrical power connector assembly according to claim 11, wherein the fastener is movably coupled to the fastener holder, and wherein the frame includes a bore configured to receive the fastener.
